(19) United States
(12) Patent Application Publication
(10) Pub. No.: US 2006/0093147 A1
(43) Pub. Date: May 4, 2006

(54) Apparatus and method for scaramling/de-scrambling 16-bit data at PCT express protocol

(76) Inventors: Won Ok Kwon, Daejeon (KR); Kyoung Park, Daejeon (KR); Myung Joon Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/263,466

(22) Filed: Oct. 31, 2005

(30) Foreign Application Priority Data
Nov. 3, 2004 (KR) 2004-88766

(51) Int. Cl. H04L 9/00

(52) U.S. Cl. 380/268

(57) ABSTRACT

An apparatus and method for scrambling/de-scrambling 16-bit data at a PCI Express protocol are provided. The apparatus includes an 8-bit precedence shift register generator for calculating an 8-bit shift register value, and outputting an 8-bit precedence shift register value through an exclusive OR (XOR) operation with 8-bit input data; and a 16-bit precedence shift register generator for more shifting the 8-bit precedence shift register value by 8 bits, assigning each register value, and outputting a 16-bit precedence shift register value through an exclusive OR (XOR) operation, whereby the 16-bit data is scrambled/de-scrambled at one clock.

### BACKGROUND OF THE INVENTION

1. Field of the Invention

The present invention relates to a scrambler/de-scrambler used at a physical layer transmitting and receiving unit of a PCI Express being a next generation computer input/output (I/O) standard, and more particularly, to an apparatus and method for scrambling/de-scrambling 16-bit data at a PCI Express protocol, for obtaining an 8-bit precedence linear feedback shift register (LFSR) and a 16-bit precedence LFSR, and making the obtained 8-bit precedence LFSR and 16-bit precedence LFSR to be compatible with a PCI Express scrambler standard to perform 16-bit data scrambling and de-scrambling.

2. Description of the Related Art

In a PCI Express protocol, a frequency of 2.5 Gbits/second un-shielded between links is transmitted, thereby seriously causing a noise of ElectroMagnetic Interference (EMI). In particular, in a repetitive pattern, energy is concentrated at a specific frequency, thereby causing a serious drawback of the EMI. Accordingly, through data scrambling/de-scrambling, power emitted to the link is varied into a white noise.

Meantime, a widely used serial data serializer/de-serializer (SERDES) has a function of a PCI Express physical media attachment layer (PMA) and a physical coding sublayer (PCS). Further, a field-programmable gate array (FPGA) embeds the programmable SERDES. In case where a PCI Express core is made using a SERDES core, it is difficult to design an 8-bit/250 MHz scrambler suggested from a PCI Express standard (PCI Express base specification revision 1.0a). This is difficult in the FPGA because in a 250 MHz synchronization design, an operation speed is too fast. Accordingly, it is advantageous that an output of the PCS layer is converted to 16-bit/125 MHz through an 8-bit to 16-bit conversion block, to construct an interface. Therefore, it is required to design a 16-bit scrambler and de-scrambler satisfying the PCI Express scrambling standard. Thus, this applicant of the present invention suggests an apparatus and method for scrambling/de-scrambling 16-bit data at a PCI Express protocol.

### SUMMARY OF THE INVENTION

Accordingly, the present invention is directed to an apparatus and method for scrambling/de-scrambling 16-bit data at a PCI Express protocol, which substantially obviates one or more problems due to limitations and disadvantages of the related art.

It is an object of the present invention to provide an apparatus and method for scrambling/de-scrambling 16-bit data at a PCI Express protocol, in which an 8-bit precedence LFSR and a 16-bit precedence LFSR can be designed to perform a necessary precedence calculation, so as to scramble 16 bits at one clock in a scrambling/de-scrambling process where an XOR operation with a PCI Express scramble polynomial coefficient is performed.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an apparatus for scrambling/de-scrambling 16-bit data at a PCI Express protocol, including: an 8-bit precedence shift register generator for calculating an 8-bit shift register value, and outputting an 8-bit precedence shift register value through an exclusive OR (XOR) operation with 8-bit input data; and a 16-bit precedence shift register generator for more shifting the 8-bit precedence shift register value by 8 bits, assigning each register value, and outputting a 16-bit precedence shift register value through an exclusive OR (XOR) operation, whereby the 16-bit data is scrambled/de-scrambled at one clock.

In another aspect of the present invention, there is provided a method for scrambling/de-scrambling 16-bit data at a PCI Express protocol, the method including the steps of: generating an 8-bit precedence shift register for the 16-bit data inputted; more shifting a value of the generated 8-bit precedence shift register by 8 bits; assigning each register value; generating a 16-bit precedence shift register; carrying out an XOR operation with each lower and upper bytes of the inputted data; and outputting final 16-bit data.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1A is a block diagram illustrating a PCI Express PHY represented using a standard of a PHY Interface for the PCI Express architecture (PIPE);

FIG. 1B is block diagrams illustrating PCI Express 8-bit scrambler/de-scrambler;

FIG. 1C is block diagrams illustrating PCI Express 16-bit scrambler/de-scrambler;

FIG. 2A is a circuit diagram where a linear feedback shift register (LFSR) is embodied using a PCI Express scrambling polynomial;

FIG. 2B is a circuit diagram illustrating a PCI Express 8-bit (de)scrambler using a precedence LFSR technique;

FIG. 2C is a block diagram illustrating a PCI Express 16-bit (de)scrambler;

FIG. 3 is a timing diagram illustrating PCI Express 8-bit data scrambling;

FIG. 4A is a 16-bit LFSR of a PCI Express scrambler;

FIG. 4B is an 8-bit precedence LFSR of a PCI Express scrambler;

FIG. 4C is a 16-bit precedence LFSR of a PCI Express scrambler;

FIG. 5 is a table where an 8-bit precedence LFSR is exclusive ORed (XORed) with Idle(00h) data;

FIG. 6 is a table of an 8-bit precedence LFSR;

FIG. 7A illustrates variations of an 8-bit precedence LFSR (LFSR8) and a 16-bit precedence LFSR (LFSR16) in PCI Express 16-bit data scrambling;

FIG. 7B illustrates scrambling of a LFSR8 and lower-byte input data at PCI Express 16-bit data scrambling;

FIG. 7C illustrates scrambling of a LFSR16 and upper-byte input data at PCI Express 16-bit data scrambling;

FIG. 7D is a timing diagram of a simulation of a function of LFSR8 and LFSR16 design block in PCI Express 16-bit data scrambling;

FIG. 7E is a block diagram of a 16-bit PCI Express (de)scrambler in PCI Express 16-bit data scrambling; and

FIG. 8 is a timing diagram of PCI Express 16-bit data scrambling.

### DETAILED DESCRIPTION OF THE INVENTION

Reference will now be made in detail to the preferred embodiments of the present invention, examples of which are illustrated in the accompanying drawings.

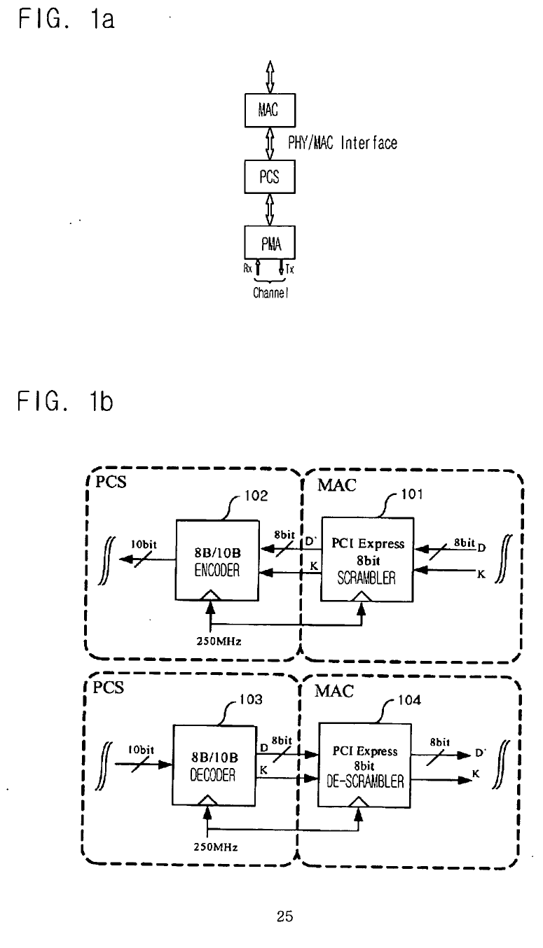

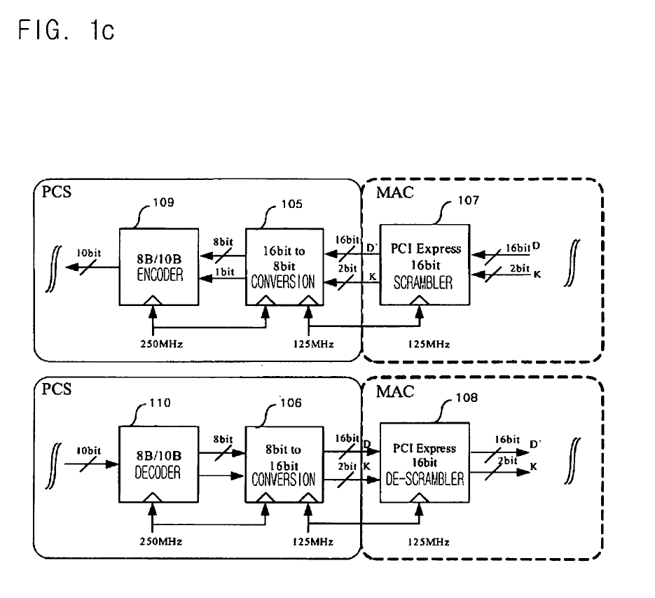

FIG. 1A schematically illustrates a PCI Express physical layer according to a standard of a physical layer (PHY) Interface for the PCI Express architecture (PIPE).

Referring to FIG. 1A, the PCI Express physical layer includes a physical media attachment layer (PMA) block (it is generally called “serializer/de-serializer (SERDES)” because of its taking charge of data serialization and de-serialization) for processing a differential serial signal of 2.5 Gbps, and a physical coding sublayer (PCS) area having an 8b/10b coding/decoding block. Most of commonly used SERDES chips, or SERDES embedded field-programmable gate arrays (FPGA) perform functions of PMA and PCS. Accordingly, when a PCI Express core is developed for the FPGA, a physical layer is begun and designed from a MAC area. In case of PCI Express, a PCS and MAC interface allows 8-bit/250 MHz or 16-bit/125 MHz. However, the 8-bit/250 MHz interface has a limitation of a FPGA operation and therefore, the 16-bit/125 MHz interface is embodied in most cases.

FIG. 1B is block diagrams illustrating scrambler/de-scrambler based on the 8-bit/250 MHz interface.

As shown in FIG. 1B, a scramble block 101 is disposed at a transmission media access control (MAC) terminal, and scrambles 8-bit data (D) and a K signal inputted from the MAC on the basis of a PCI Express standard, and transmits data (D′ and K) to an 8b/10b encoder block 102 of the PCS. The de-scramble block 102 is disposed at a first portion of a reception MAC, and de-scrambles and outputs data (D) and a K signal outputted from an 8b/10b decoder block 103 of the PCS on the basis of the PCI Express (D′ and K). At this time, the scramble block 101 and a de-scramble block 104 are perfectly the same in function and input/output signal. This is caused by a characteristic of an exclusive OR (XOR).

FIG. 1C is block diagrams illustrating scrambler/de-scrambler based on the 16-bit/125 MHz interface according to an embodiment of the present invention.

As shown in FIG. 1B, in case where the PCS and MAC interface is based on 8-bit/250 MHz, a transmission part does not include a 16-bit to 8-bit conversion block, and a reception part does not include an 8-bit to 16-bit conversion block.

However, as shown in FIG. 1C, in case where the PCS and MAC interface converts to 16-bit/250 MHz according to the present invention, the transmission part additionally includes a 16-bit to 8-bit conversion block 105, and the reception block additionally includes an 8-bit to 16-bit conversion block 106. The added 16-bit to 8-bit conversion block 105 and 8-bit to 16-bit conversion block 106 are supported by the PCS block, respectively.

In transmission, a scramble block 107 is disposed at a first terminal of the PCI Express MAC area, and in reception, a de-scramble block 108 is disposed at the first terminal. The two blocks 107 and 108 all perform a scramble or de-scramble function according to a rule of the PCI Express standard. Reference numeral 109 and 110 denote an encoder and a decoder, respectively.

Hereinafter, in order to design a PCI Express 16-bit scrambler, an operation of a linear feedback shift register (LFSR) of the PCI Express scrambler will be understood, and a 8-bit/250 MHz scrambler compatible with the PCI Express standard will be designed. Further, the 16-bit/125 MHz scrambler according to the present invention will be designed.

A polynomial of the LFSR of the PCI Express scrambler is expressed in the following Equation 1.
G(X)=X¹⁶+X⁵+X⁴+X³+1 [Equation 1]

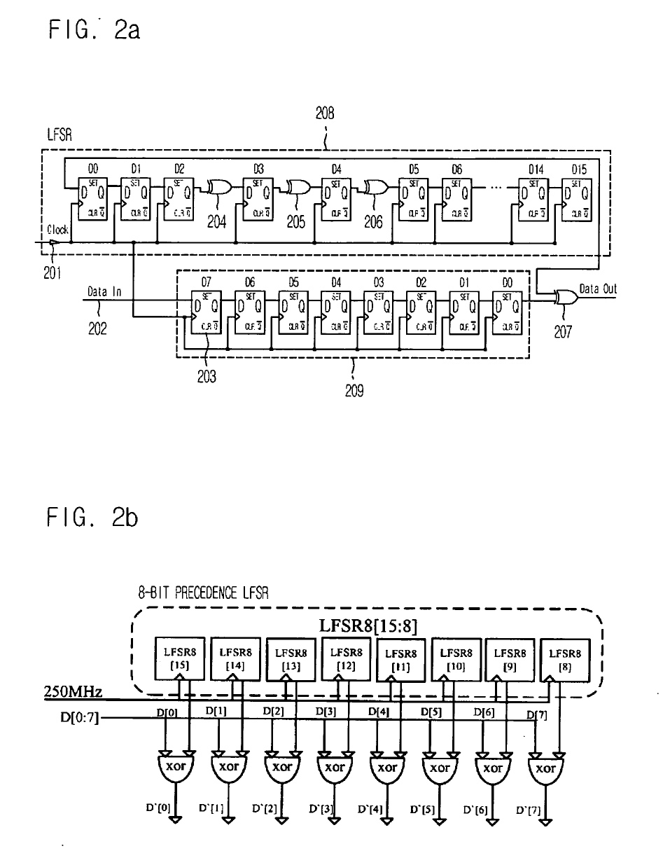

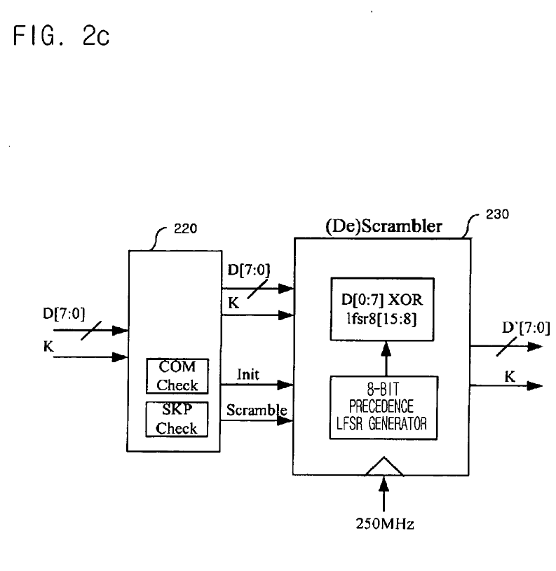

FIG. 2A is a circuit diagram of the scrambler when serial input data is applied to the polynomial of the Equation 1.

Sixteen registers (D0, . . . , D15) of a LFSR 208 have FFFFh as initial values, and their values are synchronized to a clock 201 and continue to vary. An input serial data stream 202 is inputted to and outputted from an 8-bit register 209, and is XORed (207) with an output value of the LFSR, thereby outputting finally scrambled data. This circuit cannot obtain an output (data out) of 8-bit/250 MHz until it operates at 2 GHz to be driven adaptively to the PCI Express standard. This is an operation speed difficult in realizing in the MAC area. Accordingly, an arithmetic operation of the LFSR block is previously carried out, and a pipeline typed circuit is designed. This is defined as “precedence LFSR arithmetic operation technique”. Reference numeral 203 denotes a D flip-flop, and reference numerals 204, 205 and 206 denote XORs.

FIG. 2B is a circuit where the “precedence LFSR arithmetic operation technique” is used in the scrambler circuit of FIG. 2A, to calculate an 8-bit LFSR[7:0] at a 250 MHz clock and perform a (de)scramble arithmetic operation through an XOR operation with an 8-bit input data (D[0:7]). A method for carrying out an arithmetic operation of the precedence 8-bit LFSR (LFSR8) in the LFSR circuit of FIG. 2A is expressed in the following Table 1.

TABLE 1
LFSR8

| Reg | | d0 | d1 | d2 | d3 | d4 | d5 | d6 | d7 | d8 | d9 | d10 | d11 | d12 | d13 | d14 | d15 |
|---|---|---|---|---|---|---|---|---|---|---|---|---|---|---|---|---|---|
| data | a | 8 | 9 | 10 | 11 | 12 | 13 | 14 | 15 | 0 | 1 | 2 | 3 | 4 | 5 | 6 | 7 |
| | b | | | | 8 | 9 | 10 | 11 | 12 | 13 | 14 | 15 | | | | | |
| | c | | | | | 8 | 9 | 10 | 11 | 12 | 13 | 14 | 15 | | | | |
| | d | | | | | | 8 | 9 | 10 | 11 | 12 | 13 | 14 | 15 | | | |

An initial value of “1” is inputted to the sixteen registers from LFSR D0 to D15 of FIG. 2A (LFSR initial value is 0×FFFF). In order to obtain an 8-bit precedence LFSR value, after eight clocks 201, the value inputted to each of the registers should be traced. First, a state of the register where 8-bit data is shifted and stored is expressed like a column “a”. Zero is inputted to the D8 register. This means that a value of the D0 register is shifted and stored. A value of the D7 register is shifted and stored in the D15 register. Additionally, influence from three XORs 204, 205 and 206 should be considered. In other words, due to the XOR 204, outputs of the D15 to D8 registers have influence on the D10 to D3 registers. Due to the XOR 205, the outputs of the D15 to D8 registers have influence on the D11 to D4 registers. Due to the XOR 206, the outputs of the D15 to D8 registers have influence on the D12 to D5 registers. Here, the precedence 8-bit LFSR is values of the D15 to D8 registers (that is because, after 8 bits, input data reaches the D0 register, and values of the D15 and D0 registers are XORed 207 and outputted). That is, it can be expressed as follows:
Data out[7:0=D[0:7]XOR LFSR8[15:8] [Equation 2]

The 8-bit precedence LFSR value of FIG. 2B is expressed as in the following Equation 3:
lfsr8[0=lfsr[8]
lfsr8[1=lfsr[9]
lfsr8[2=lfsr[10]
lfsr8[3]=lfsr[11]⊕lfsr[8]
lfsr8[4]=lfsr[12]⊕lfsr[9]⊕lfsr[8]
lfsr8[5]=lfsr[13]⊕lfsr[10]⊕lfsr[9]⊕lfsr[8]
lfsr8[6]=lfsr[14]⊕lfsr[11]⊕lfsr[10]⊕lfsr[9]
lfsr8[7]=lfsr[15]⊕lfsr[12]⊕lfsr[11]⊕lfsr[10]
lfsr8[8]=lfsr[0]⊕lfsr[13]⊕lfsr[12]⊕lfsr[11]
lfsr8[9]=lfsr[1]⊕lfsr[14]⊕lfsr[13]⊕lfsr[12]
lfsr8[10]=lfsr[2]⊕lfsr[15]⊕lfsr[14]⊕lfsr[13]
lfsr8[11]=lfsr[3]⊕lfsr[15]⊕lfsr[14]
lfsr8[12]=lfsr[4]⊕lfsr[15]
lfsr8[13]=lfsr[5]
lfsr8[14]=lfsr[6]
lfsr8[15]=lfsr[7] [Equation 3]

Here, a bigoplus (⊕) denotes the XOR operation. At this time, bits used for (de)scrambling are upper 8 bits of the 8-bit LFSR, and are expressed in a bold character as in the Equation 3.

After the arithmetic operation of the 8-bit precedence LFSR, a scramble rule of the PCI Express standard is applied to the circuit. The next is a (de)scramble rule of a PCI Express protocol standard.

(a) In a multi lane link, the LFSR between lanes should be necessarily designed to have the same value.

(b) Scrambling is applied to data of TLP and DLLP, and even a logical idle (00h) is included. However, data within TS1 or TS2 is not included.

(c) Control characters (K) within order sets (TS1, TS2, SKP, FTS, and Electrical Idle) are not scrambled.

(d) A compliance pattern is not scrambled.

(e) Even a COM symbol (K28.5) is not scrambled, and initializes the LFSR value. The initial value is FFFFh. Even in a de-scrambler block of a reception terminal of a link counterpart, the LFSR value is initialized by the received COM symbol.

(f) The LFSR value is precedently calculated for all data and control characters, but is not precedently calculated for a SKP symbol included in the SKP ordered-set. This is because, in a SKP character, a link speed increases and decreases in its control, thereby being against synchronization of the LFSR value.

(g) The scrambler is always enabled. However, the exception is a case where scramble disable of TS is used for test. SW can disable the scramble, but its method is not disclosed in the standard.

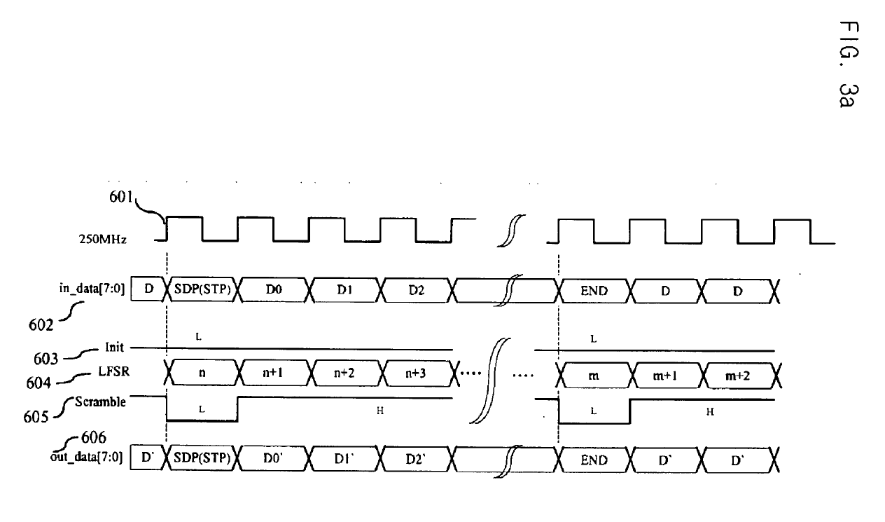

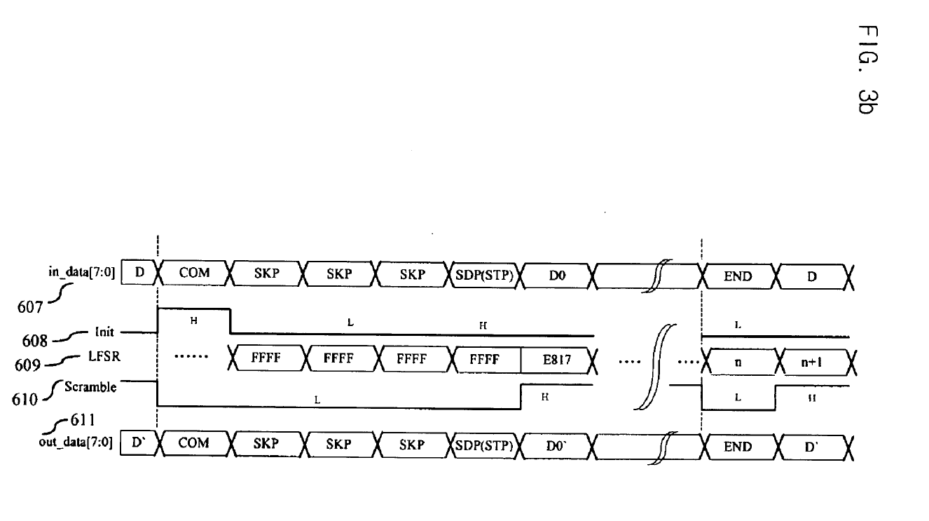

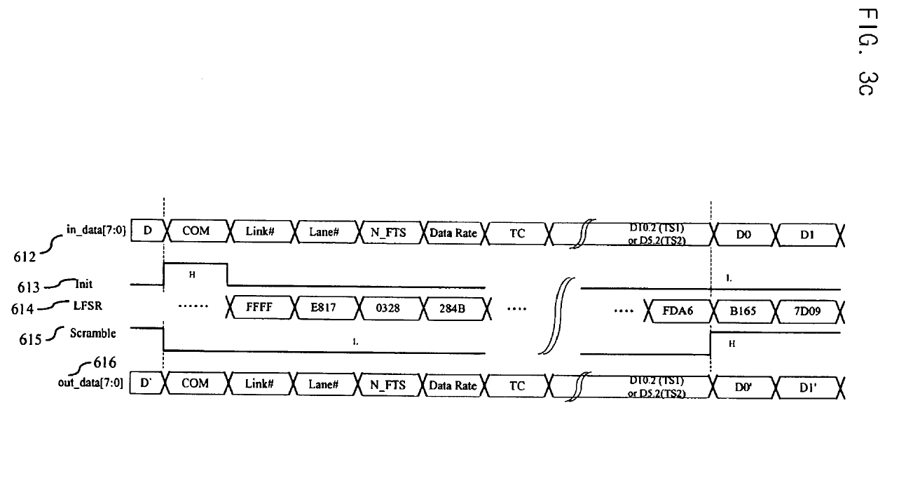

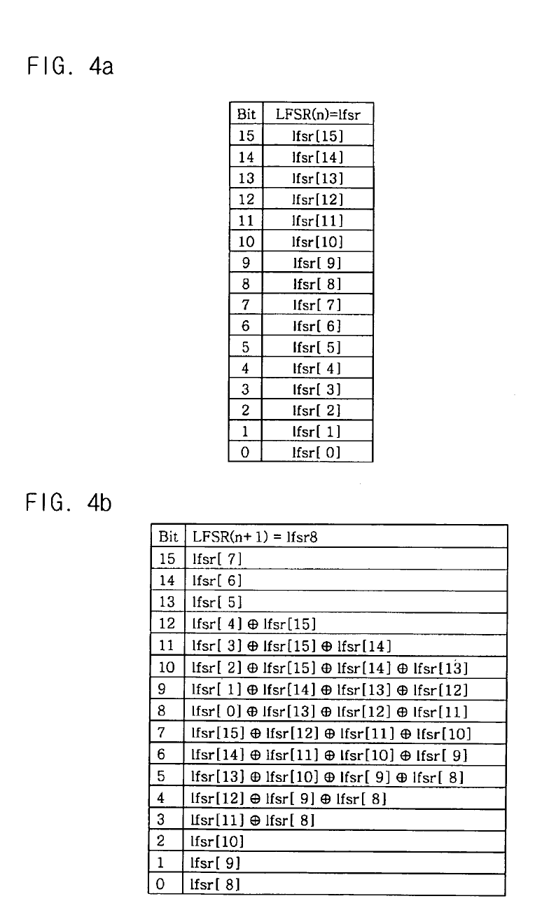

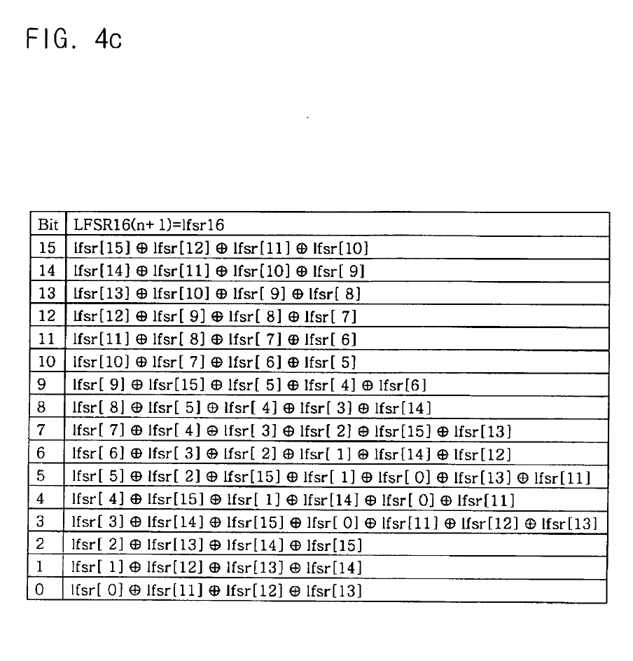

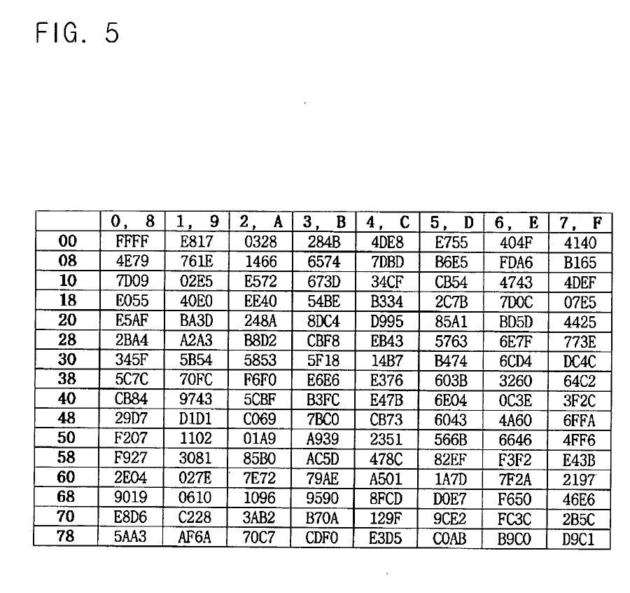

FIG. 2C schematically illustrates a 8-bit/250 MHz PCI Express (de)scrambler apparatus designed on the basis of the PCI Express (de)scrambling rule. As shown in FIG. 2C, it includes a symbol check block 220 for checking the COM symbol and the SKP ordered-set in the input data (D[7:0]), and a (de)scramble block 230 for performing the (de)scramble. In order to observe the PCI Express scramble rule, the symbol check block 220 outputs an Init signal generated when a COM signal is found, and a scramble signal for controlling as to whether or not the scramble is performed. The scramble signal follows the PCI Express scramble rule, and this is shown in FIG. 3. The (de)scramble block 230 generates the LFSR values as shown in Equations of FIG. 4B, and performs the XOR operation with the input data, and outputs data.

FIG. 3 is a timing diagram of (de)scrambling of an 8-bit/250 MHz PCI Express packet.

First, FIG. 3A illustrates an operation of the (de)scrambler when a DLLP or TLP packet 602 is inputted to a 250 MHz clock 601. An Init control signal 603 is varied to be in a high state when the COM symbol is inputted. At this time, the LFSR value is reset (FFFFh). If the Init control signal is in a low state, the LFSR 604 varies as shown in a variation table of FIG. 5. A scramble control signal 605 is varied to be in a low state only in case of the K symbol, the SKP, and the TS, and at this time, the scrambling is not performed. In FIG. 3A, in case of the SDP (STP) and the END, that is, in case of inputting of the K symbol, the scramble control signal 605 is in a low state, and others are in high states. Only when output data 606 of the final (de)scrambler is set, the 8-bit precedence LFSR and the input data are XORed and outputted, and in case where the scramble control signal 605 is in a low state, the input data is outputted as it is.

FIG. 3B illustrates an operation when the SKP and the DLLP (TLP) packets are inputted to the 8-bit input data (in data[7:0]) 607 at the 250 MHz clock 601. The Init control signal 608 for initializing the LFSR to the FFFFh is set to the COM symbol input of the SKP ordered-set. At a next clock, the LFSR 609 value is initialized to the FFFFh. After the COM, next three input symbols are the SKP and therefore, the LFSR does not vary and the FFFFh value is outputted. After that, when the SDP (STP) is inputted, the LFSR varies in a sequence of E817h, 0328h, and the like as shown in the table value of FIG. 5. At this time, in case of the SKP ordered-set, the SDP (STP) being the K symbol, and the END, the scramble control signal 610 is in a low state and subsequently gets to be in a high state. Only when the scramble control signal 610 is set, the 8-bit precedence LFSR value and the input data are XORed, thereby outputting output data (out_data[7:0]) 611.

FIG. 3C illustrates an operation when the TS ordered-set and the Idle (00h) packet are inputted to 8-bit input data in_data[7:0] 612 at the 250 MHz clock 601. Init control signal 613 for initializing the LFSR to the FFFFh is set to the input of the COM symbol. At a next clock, a LFSR value 614 is initialized to the FFFFh. After that, as shown in a table value of FIG. 5, the LFSR is varied in a sequence of E817h, 0328h and the like. When the TS ordered-set is transmitted, the scramble control signal is zero and, is subsequently set. Only when the scramble control signal 615 is set, output data (out data[7:0]) 616 is XORed with the 8-bit precedence LFSR and is outputted.

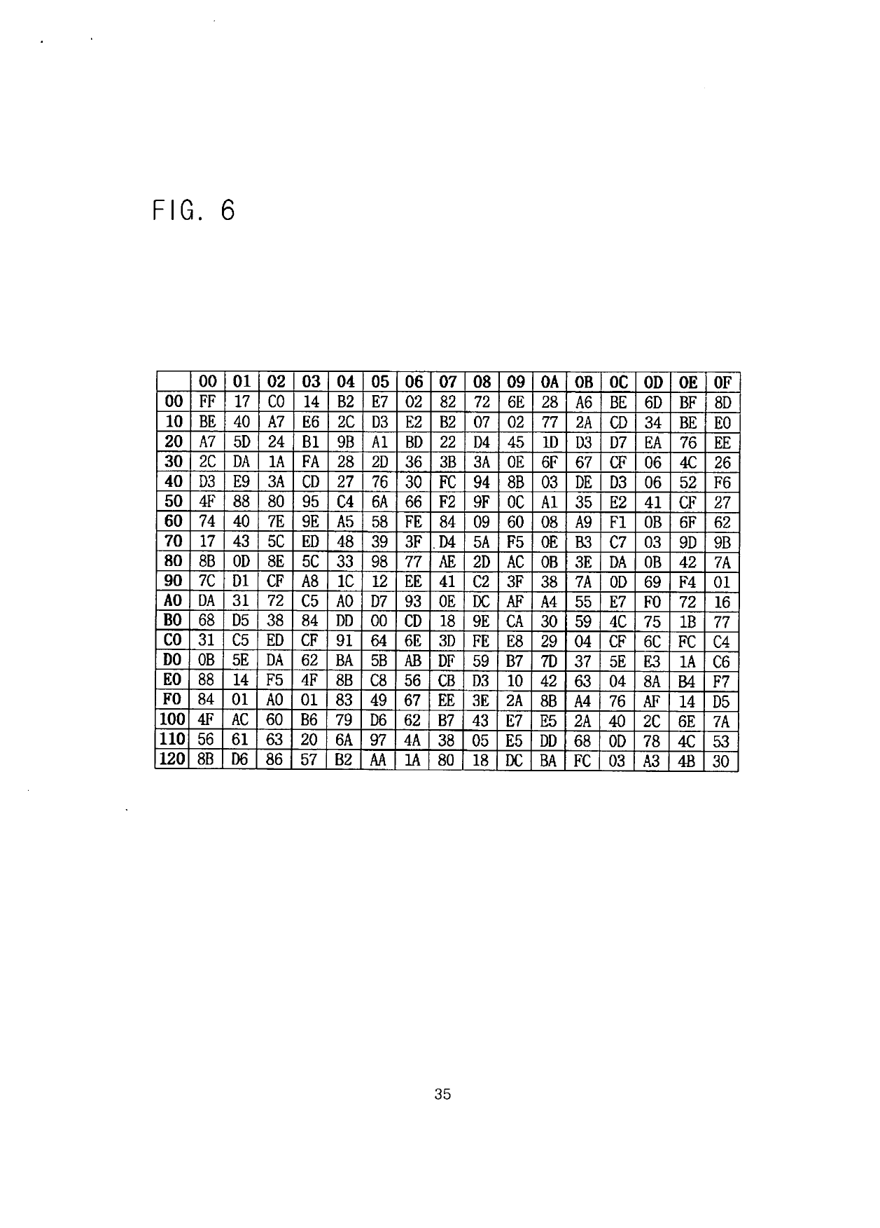

FIG. 5 illustrates a data value (de)scrambled when the input data (D[7:0]) is the Idle(00h). FIG. 6 is a precedence 8-bit LFSR table. The two tables are proved using the Equation 3. If this table is used, a verification of the precedence LFSR can be performed.

The 16-bit/125 MHz (de)scrambler based on the design of the 8-bit/250 MHz is designed as follows. First, in order to extend the interface to 16 bits, the 16-bit precedence LFSR value should be obtained. Even in a subsequent 16-bit/125 MHz operation, it is designed to satisfy the PCI Express (de)scramble standard.

In order to precedently calculate the LFSR value of the 16 bits (two symbols), the above obtained 8-bit precedence LFSR is used as the LFSR of the low byte (in_data[0:7]), and the 16-bit precedence LFSR is used as the LFSR of the upper byte (in_data[8:15]). The 16-bit precedence LFSR (LFSR16) can be searched by once more applying a method for obtaining the 8-bit precedence LFSR value of the Table 1. Table 2 represents a table of the 16-bit precedence LFSR.

TABLE 2
LFSR16

| Reg | | d0 | d1 | d2 | d3 | d4 | d5 | d6 | d7 | d8 | d9 | d10 | d11 | d12 | d13 | d14 | d15 |
|---|---|---|---|---|---|---|---|---|---|---|---|---|---|---|---|---|---|
| data | a | 0 | 1 | 2 | 3 | 4 | 5 | 6 | 7 | 8 | 9 | 10 | 11 | 12 | 13 | 14 | 15 |
| b | 13 | 14 | 15 | | | | | | | | | 8 | 9 | 10 | 11 | 12 | |
| c | 12 | 13 | 14 | 15 | | | | | | | | | 8 | 9 | 10 | 11 | |
| d | 11 | 12 | 13 | 14 | 15 | | | | | | | | | 8 | 9 | 10 | |
| e | | | | 0 | 1 | 2 | 3 | 4 | 5 | 6 | 7 | | | | | | |
| f | | | | 13 | 14 | 15 | | | | | | | | | | | |
| g | | | | 12 | 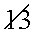 | 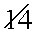 | 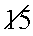 | | | | | | | | | | |
| h | | | | 11 | 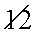 | 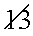 | 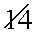 | 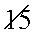 | | | | | | | | | |
| i | | | | | 0 | 1 | 2 | 3 | 4 | 5 | 6 | 7 | | | | | |
| j | | | | | 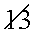 | 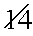 | 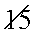 | | | | | | | | | | |
| k | | | | | 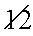 | 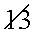 | 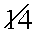 | 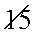 | | | | | | | | | |
| l | | | | | 11 | 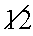 | 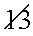 | 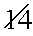 | 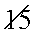 | | | | | | | | |
| m | | | | | | 0 | 1 | 2 | 3 | 4 | 5 | 6 | 7 | | | | |
| n | | | | | | 13 | 14 | 15 | | | | | | | | | |
| o | | | | | | 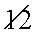 | 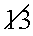 | 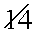 | 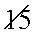 | | | | | | | | |
| p | | | | | | 11 | 12 | 13 | 14 | 15 | | | | | | | |

If the 8-bit precedence LFSR of the Table 1 is more shifted by 8-bits in order to obtain the 16-bit precedence LFSR, each register value is assigned such as bold characters of columns “a” to “d” of the Table 2. Further, in FIG. 2A, three XOR influences are reflected on the table. First, the XOR 204 of FIG. 2A has influence on data of columns “e” to “h”. Second, the XOR 205 of FIG. 2A has influence on data of columns “e” to “1”. Last, the XOR 206 of FIG. 2A has influence on data of columns “m” to “p”. A slant-lined portion of the Table 2 could be removed by an even number in a characteristic of XOR calculation, and therefore was removed. Accordingly, the 16-bit precedence LFSR value (LFSR16) is expressed in Equation 4.
lfsr16[0]=lfsr[0]⊕lfsr[11]⊕lfsr[12]⊕lfsr[13]
lfsr16[1]=lfsr[1]⊕lfsr[12]⊕lfsr[13]⊕lfsr[14]
lfsr16[2]=lfsr[2]⊕lfsr[13]⊕lfsr[14]⊕lfsr[15]
lfsr16[3]=lfsr[3]⊕lfsr[14]⊕lfsr[15]⊕lfsr[0]⊕lfsr[11]⊕lfsr[12]⊕lfsr[13]
lfsr16[4]=lfsr[4]⊕lfsr[15]⊕lfsr[1]⊕lfsr[14]⊕lfsr[0]⊕lfsr[11]
lfsr16[5]=lfsr[5]⊕lfsr[2]⊕lfsr[15]⊕lfsr[1]⊕lfsr[11]⊕lfsr[13]⊕lfsr[11]
lfsr16[6]=lfsr[6]⊕lfsr[3]⊕lfsr[2]⊕lfsr[1]⊕lfsr[14]⊕lfsr[12]
lfsr16[7]=lfsr[7]⊕lfsr[4]⊕lfsr[3]⊕lfsr[2]⊕lfsr[15]⊕lfsr[13]
lfsr16[8]=lfsr[8]⊕lfsr[5]⊕lfsr[4]⊕lfsr[3]⊕lfsr[14]
lfsr16[9]=lfsr[9]⊕lfsr[15]⊕lfsr[5]⊕lfsr[4]⊕lfsr[6]
lfsr16[10]=lfsr[10]⊕lfsr[7]⊕lfsr[6]⊕lfsr[5]
lfsr16[11]=lfsr[11]⊕lfsr[8]⊕lfsr[7]⊕lfsr[6]
lfsr16[12]=lfsr[12]⊕lfsr[9]⊕lfsr[8]⊕lfsr[7]
lfsr16[13]=lfsr[13]⊕lfsr[10]⊕lfsr[9]⊕lfsr[8]
lfsr16[14]=lfsr[14]⊕lfsr[11]⊕lfsr[10]⊕lfsr[9]
lfsr16[15]=lfsr[15]⊕lfsr[12]⊕lfsr[11]⊕lfsr[10] [Equation 4]

The LFSR 16 also uses only the upper 8 bits expressed in the bold character for the scramble. That is, it is expressed in the following Equation.
Data out[15:8=D[8:15]XOR LFSR16[15:8] [Equation 5]

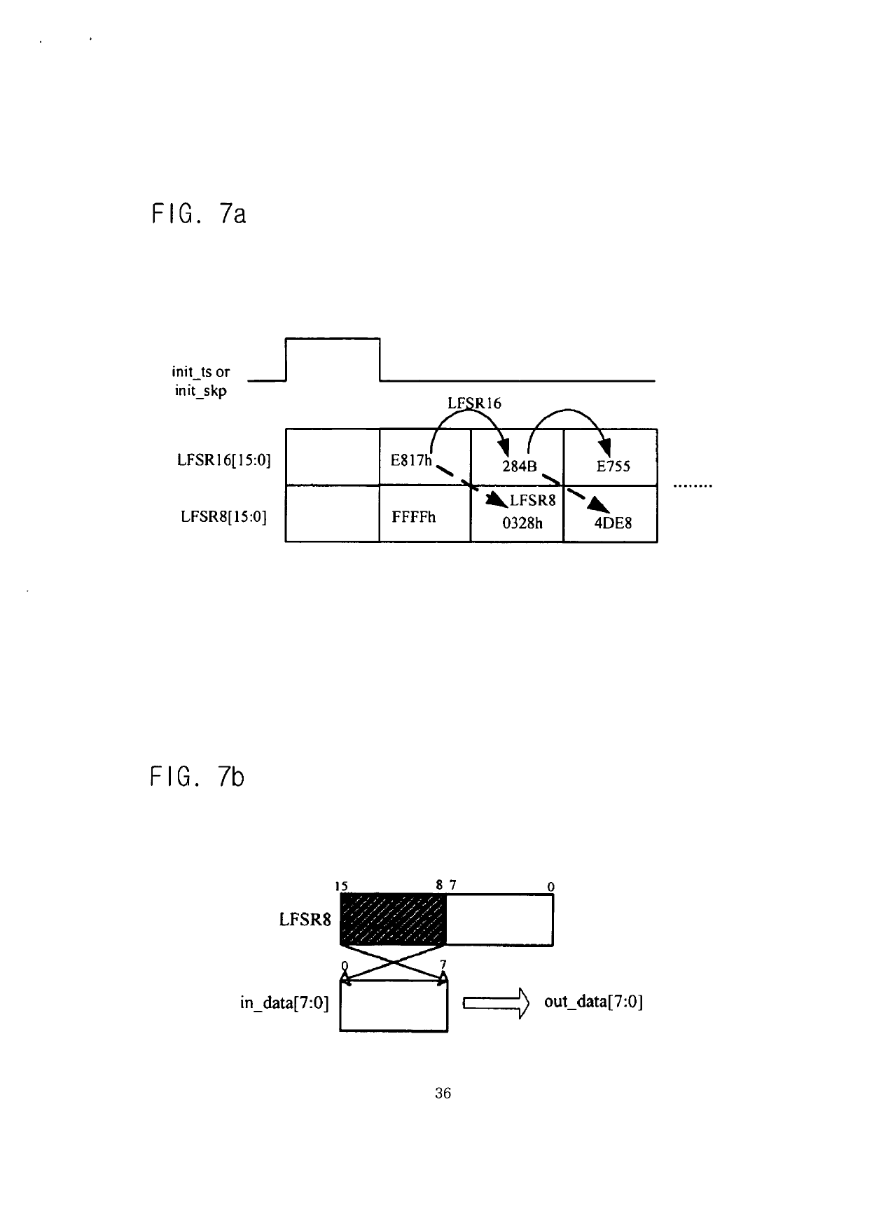

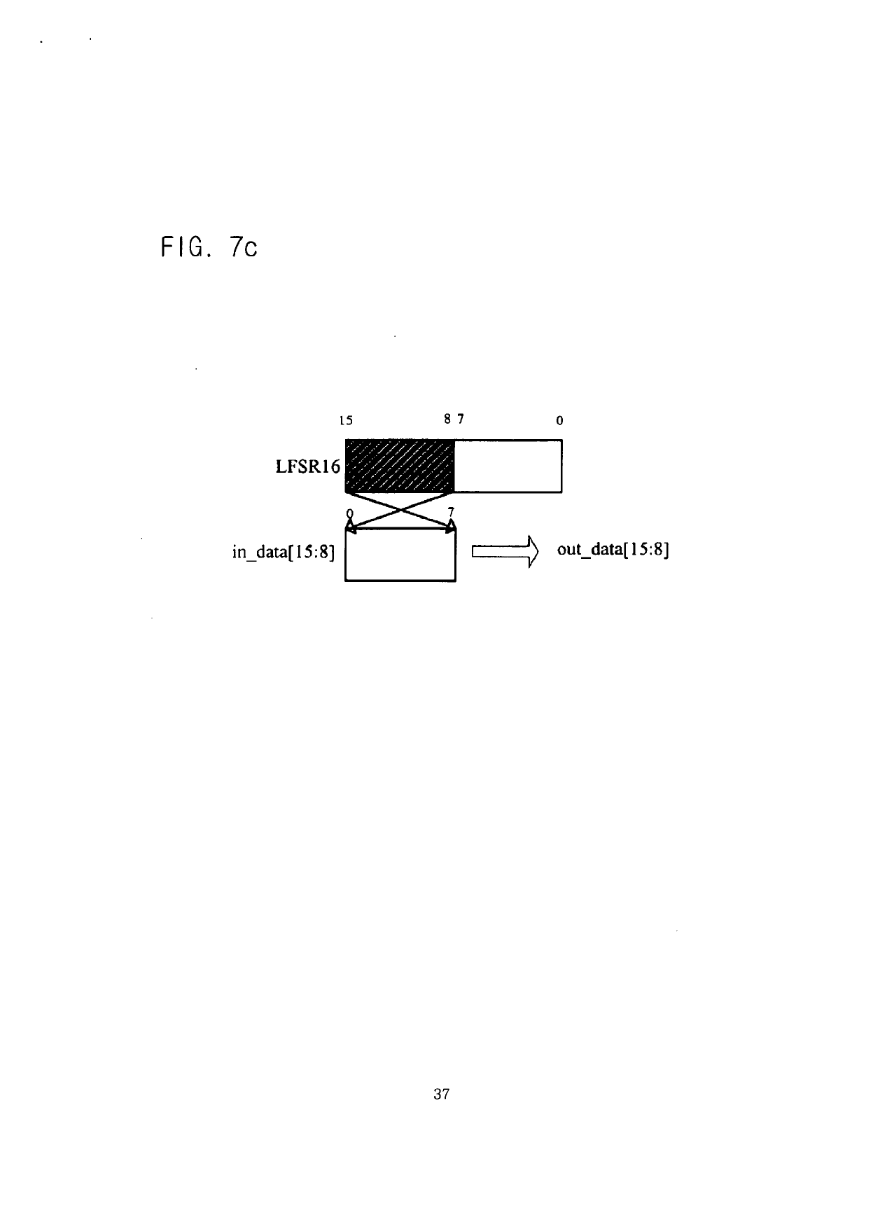

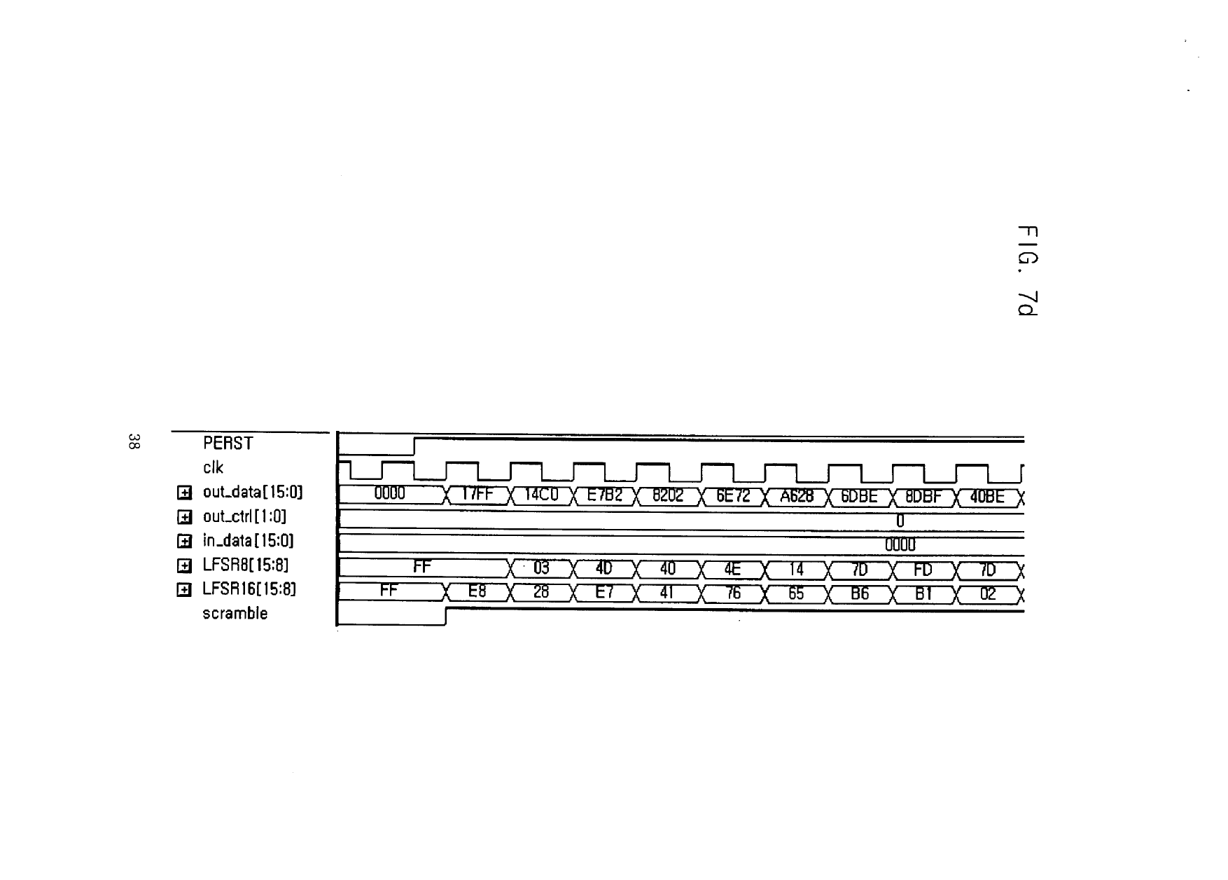

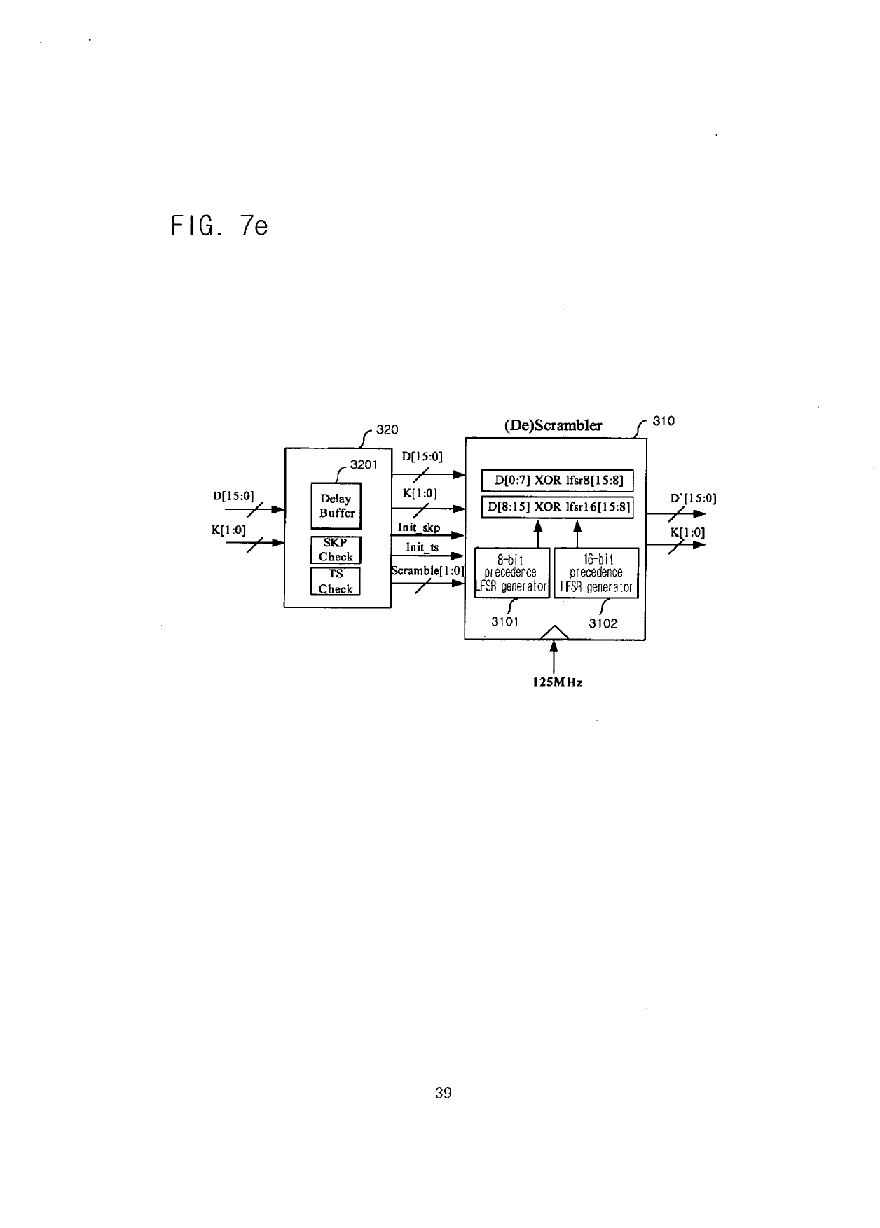

FIG. 7A illustrates variations of the LFSR8 and the LFSR16 as a result of (de)scrambling of the input data Idle(00h) using the LFSR8 and the LFSR16. If the SKP and TS ordered-sets including the COM symbol are inputted, the init_skp signal or the init_ts signal is set. At a next clock, the LFSR8 is initialized to the FFFFh, and the LFSR16 is initialized to the E817h. After that, the LFSR8 outputs the 8-bit precedence LFSR value, that is, the E817h on the basis of the LFSR16 value (FFFFh). Through the Equation 3 based on the E817h value, the 0328h value of the LFSR8 is obtained. Through the Equation 4, the 284Bh of the LFSR16 is obtained. Similarly, on the basis of the 284Bh, the 4DE8h and the E755h values being the LFSR8 and the LFSR16 values are generated. These are accurately consistent with the LFSR variation table of FIG. 5. The LFSR8 is generated by an 8-bit precedence LFSR algorithm based on the value of the LFSR16, and the LFSR16 value is generated by a 16-bit precedence LFSR algorithm based on a value of a LFSR16 of a previous clock. As such, by concurrently obtaining the LFSR16 value necessary for the upper byte and the LFSR8 value necessary for the lower byte, the 16-bit data (2 bytes=2 symbols) can be all (de)scrambled at one clock.

The 16 bit LFSR8 and LFSR16 values are XORed with the input data as shown in FIGS. 7A and 7B, and are outputted. These are expressed in the following Equations 6 and 7.
Scrambled lower byte data=out_data[7:0=LFSR8[15:8]XOR in_data[0:7] [Equation 6]
Scrambled upper byte data=out_data[15:8]=LFSR16[15:8]XOR in_data[8:15] [Equation 7]

FIG. 7D is a simulation result of a scramble block designed using the algorithm according to the present invention. As in FIG. 5, the LFSR8[15:8] and LFSR16[15:8] values vary such as FFh, E8h, 03h, 28h, and 4Dh. At this time, the scrambled output values of input data 0000h are 17FFh, 14C0h, and the like, and are accurately consistent with the scramble table of the Idle data of FIG. 6.

FIG. 7E is a block diagram of a (de)scrambler for a 16-bit/125 MHz PCI Express protocol according to the present invention. At a front terminal of a scrambler block 310, there are provided a TS and SKP ordered-sets check block 320 and a data delay buffer 3201. This check block 320 receives the 16-bit data, and outputs the Init_skp signal for informing the SKP ordered-set, and the Init_ts signal for informing the TS ordered-set through symbol check. Further, whether or not scrambling is performed for each byte of 16 bits (2 symbols) is outputted through a 2-bit scramble signal. The (de)scramble block 310 include an 8-bit precedence LFSR generator 3101, and a 16-bit precedence LFSR generator 3102. The (de)scramble block 310 performs the XOR operation with the lower and upper bytes of the input data, respectively, and outputs final 16 bit data and each K symbol. At this time, it is compared with the symbol check block used for the 8-bit/250 MHz interface, and as the comparison result, there are variations of the Init output signal and the Scramble output signal as follows.

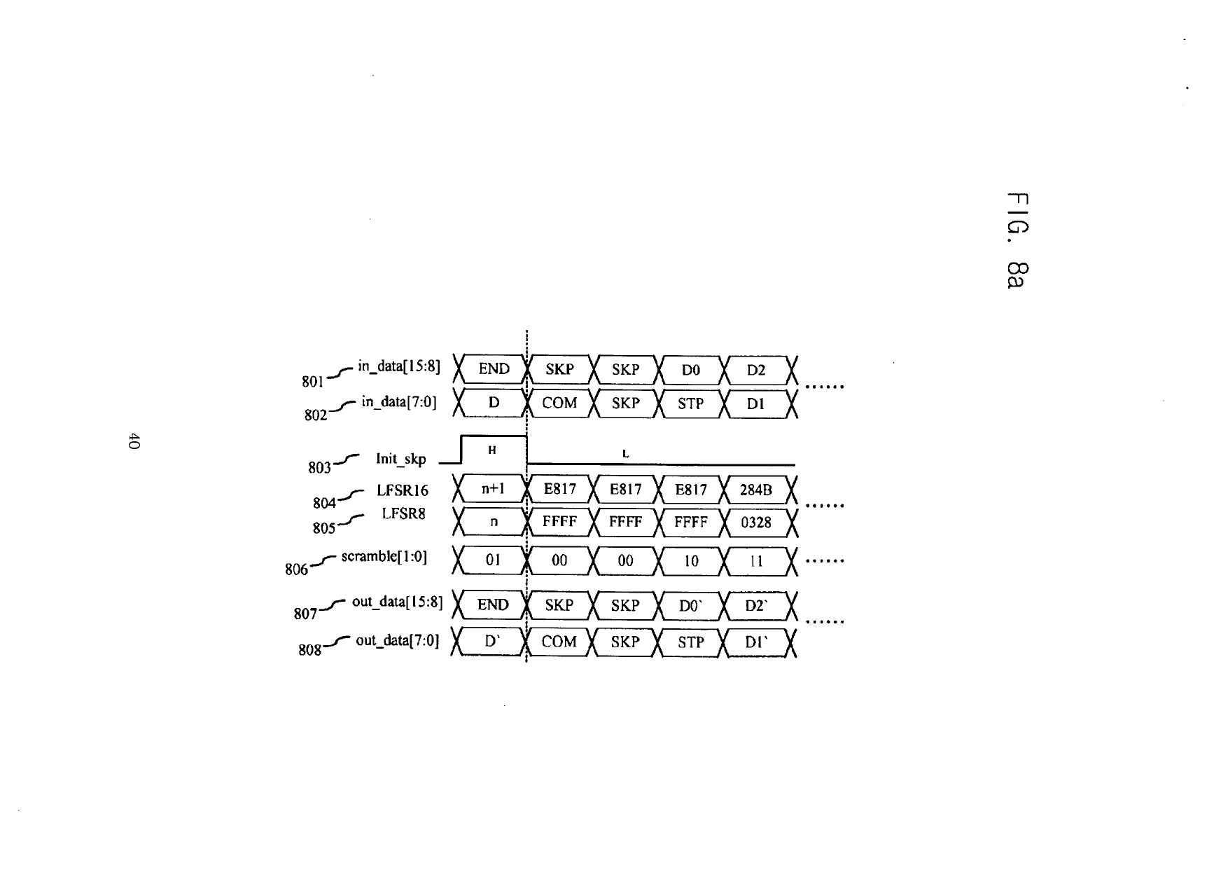

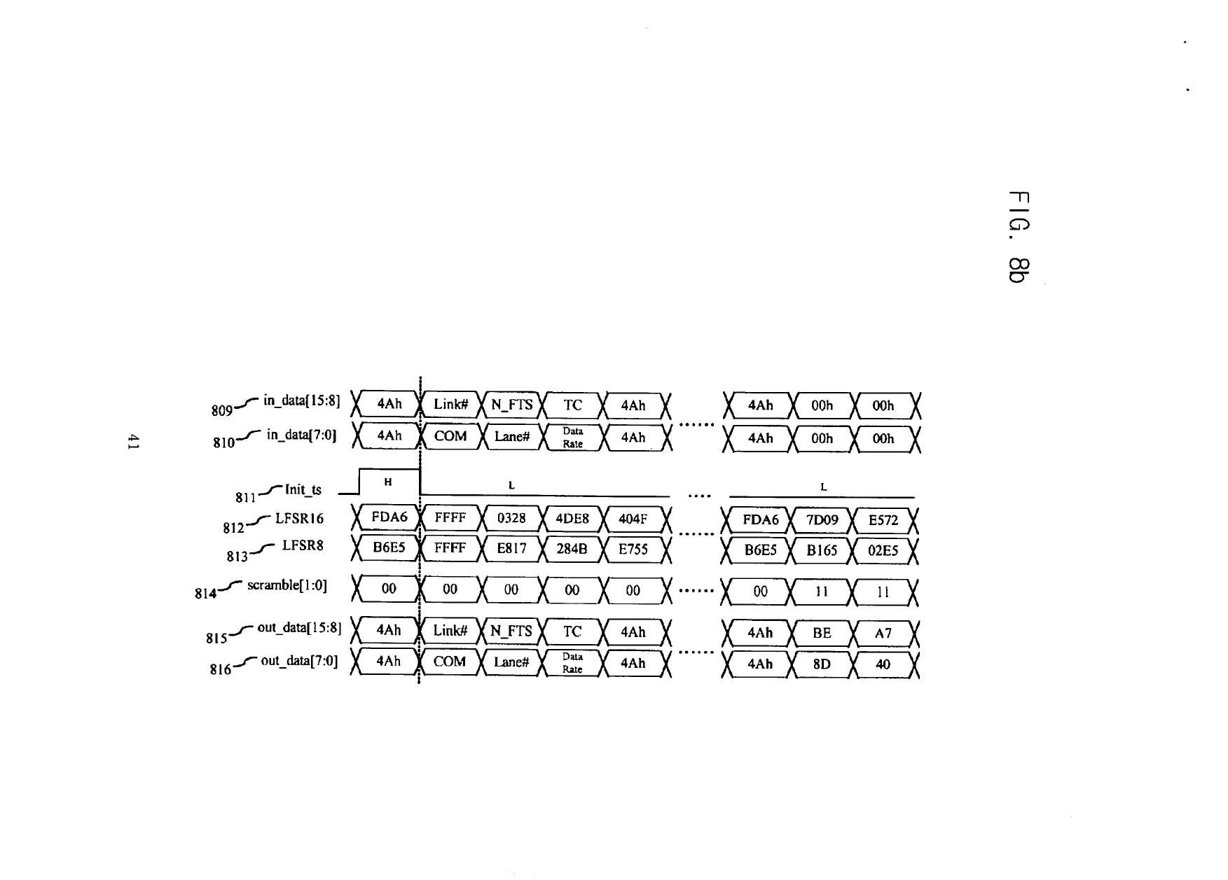

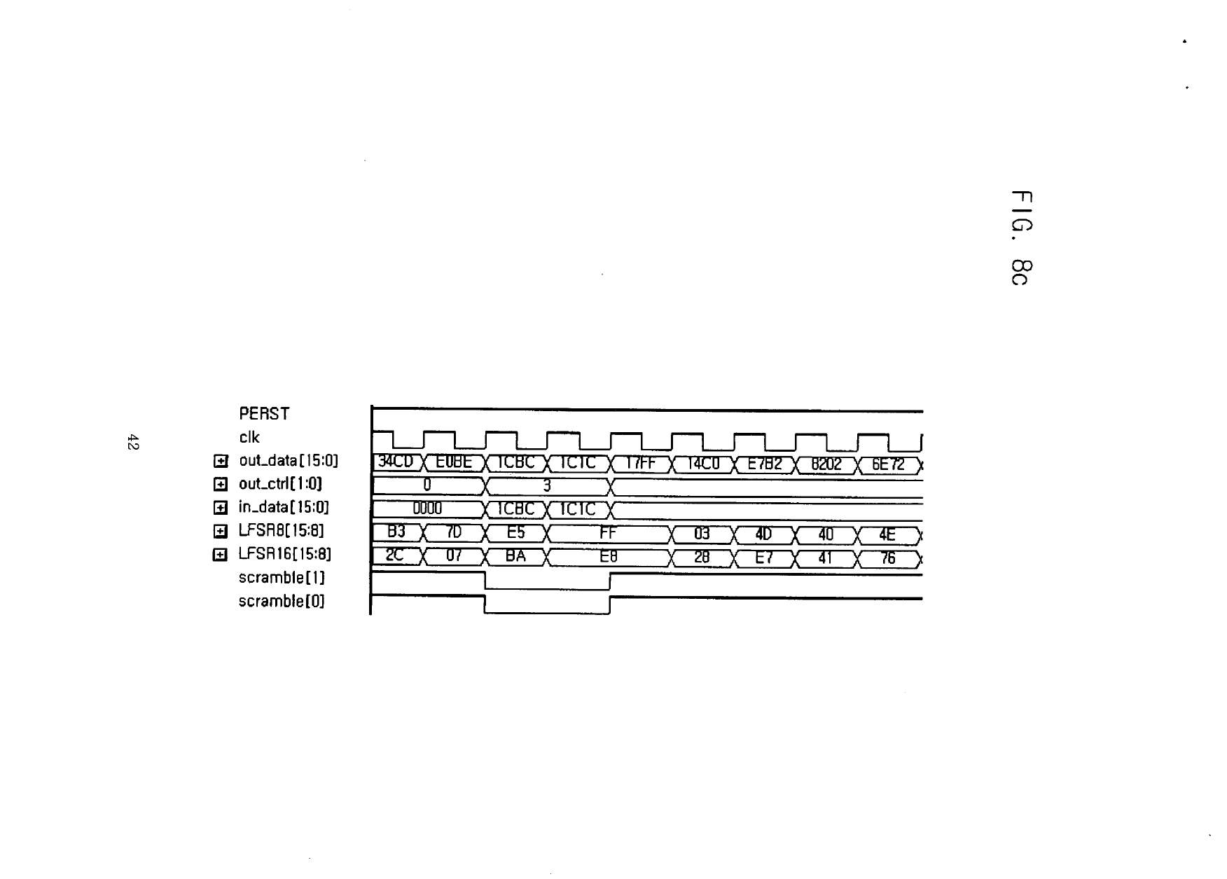

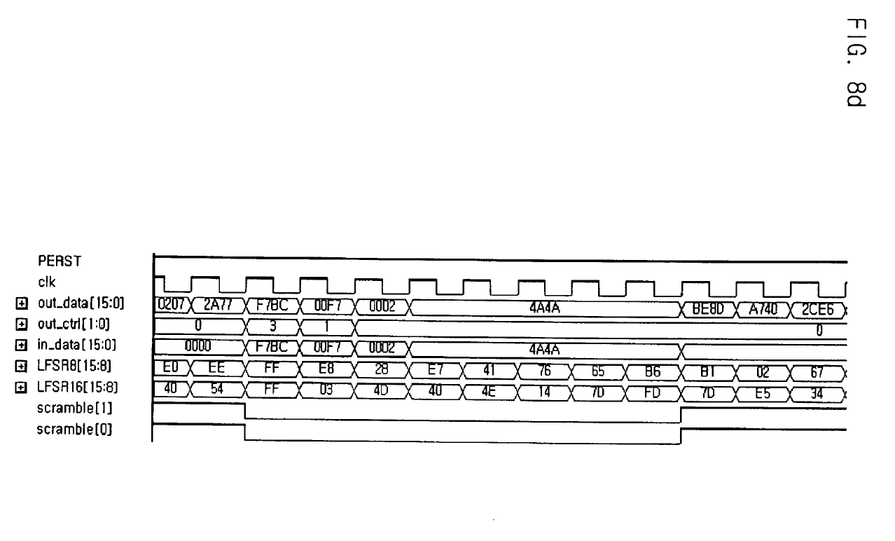

As the control signal for initializing the LFSR, the 8-bit/250 MHz interface uses only the Init signal 603, but the 16-bit/125 MHz interface uses two control signals (init_ts and init_skp). Unlike the 8-bit/250 MHz interface, the 16-bit/125 MHz interface should generate the init control signal at earlier than one clock of the COM symbol (125 MHz). Unlike the SKP ordered-set, the TS ordered-set 612 should update the LFSR value from a next link-number symbol of the COM symbol. However, in case of the SKP ordered-set, the LFSR needs to update even at the next three SKP symbols of the COM symbol. As indicated by reference numeral 809 of FIG. 8B, a link number is inputted to the same clock as the COM symbol. Accordingly, the LFSR value to be applied to the link number is not varied. This is because the LFSR8 and LFSR16 values are all clock-synchronized outputs. Accordingly, the init_ts signal or the init_skp signal should be generated at earlier than a COM symbol transmission clock, at a front terminal of the scrambler in the scramble process, and at the symbol check block 310 in the de-scramble process. At this time, in case of the SKP ordered-set, the init_skp signal is generated, and in case of the TS, FTS, Electrical Idle ordered-sets, the init_ts signal is generated.

FIG. 8A illustrates an operation of the 16-bit/125 MHz (de)scrambler suggested in the present invention in case of inputting of the SKP ordered-set. The SKP ordered-set is comprised of four bytes (COM-SKP-SKP-SKP). Additionally, the SKP ordered-set section has no LFSR updating. Accordingly, a next LFSR value of the SKP ordered-set has an initial value of LFSR8=FFFF, and LFSR16 =E817. Accordingly, the init_skp signal varies to LFSR8=FFFF and LFSR16=E817. At this time, two symbols should be processed at one clock of the scramble[1:0] control signal 806 and therefore, 2-bit extension is performed. In case where the scramble control signal is “00”, the two symbols are not all scrambled. In case of “01”, only a lower byte is scrambled, and in case of “10”, only an upper byte is scrambled. In case of “11”, two bytes are all scrambled. In FIG. 8A, the scramble control signal is in a low state in the K symbol such as STP or END.

FIG. 8B illustrates a case where the TS ordered-set is inputted in the 16-bit/125 MHz (de)scrambler according to the present invention. In the TS ordered-set, the LFSR value varies from a COM next link number, and all of the TS ordered-set is not (de)scrambled. Accordingly, the link number has a value of LFSR=FFFFh. Accordingly, if the init_ts signal is inputted, the link number has an initial value of LFSR8=LFSR16=FFFFh. This is identically applied even to the FTS and Electrical Idle ordered-sets having the COM symbol.

FIGS. 8C and 8D are simulation results of 16-bit/125 MHz (de)scrambler design block according to the present invention. FIG. 8C is a timing diagram illustrating the simulation result when the SKP ordered-set is inputted between the Idle inputs, and FIG. 8D is the simulation result when the TS ordered-set is inputted between the Idle inputs. In FIG. 8C, it can be confirmed that the output data scrambled with the LFSR8 and the LFSR16 in the KSP ordered-set inputted between the Idles. Output data after the SKP is accurately consistent with FIG. 6.

As described above, in the inventive apparatus and method for scrambling/de-scrambling the 16-bit data at the PCI Express protocol, the scrambler/de-scrambler can be effectively embodied when the PCS and MAC interface of the PCI Express protocol physical layer is based on 16-bit/125 MHz.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus for scrambling/de-scrambling 16-bit data at a PCI Express protocol, comprising:
an 8-bit precedence shift register generator for calculating an 8-bit shift register value, and outputting an 8-bit precedence shift register value through an exclusive OR (XOR) operation with 8-bit input data; and
a 16-bit precedence shift register generator for more shifting the 8-bit precedence shift register value by 8 bits, assigning each register value, and outputting a 16-bit precedence shift register value through an exclusive OR (XOR) operation,
whereby the 16-bit data is scrambled/de-scrambled at one clock.

2. The apparatus of claim 1, wherein the 16-bit precedence shift register generator comprises:
an exclusive OR (XOR) for carrying out an operation of a third shift register, a fourth shift register, a fifth shift register, an eighth shift register, and a fourteenth shift register, and outputting a ninth shift register value;
an exclusive OR (XOR) for carrying out an operation of the fourth shift register, the fifth shift register, a sixth shift register, the ninth shift register, and a fifteenth shift register, and outputting a tenth shift register value;
an exclusive OR (XOR) for carrying out an operation of the fifth shift register, the sixth shift register, a seventh shift register, and a twentieth shift register, and outputting an eleventh shift register value;
an exclusive OR (XOR) for carrying out an operation of the sixth shift register, the seventh shift register, the eighth shift register, and the eleventh shift register, and outputting a twelfth shift register value;
an exclusive OR (XOR) for carrying out an operation of the seventh shift register, the eighth shift register, the ninth shift register, and the twelfth shift register, and outputting a thirteenth shift register value;
an exclusive OR (XOR) for carrying out an operation of the eighth shift register, the ninth shift register, the tenth shift register, and a thirteenth shift register, and outputting a fourteenth shift register value;
an exclusive OR (XOR) for carrying out an operation of the ninth shift register, the tenth shift register, the eleventh shift register, and the fourteenth shift register, and outputting the fifteenth shift register value; and
an exclusive OR (XOR) for carrying out an operation of the tenth shift register, the eleventh shift register, the twelfth shift register, and the fifteenth shift register, and outputting the sixteenth shift register value.

3. The apparatus of claim 1, wherein in a method for scrambling/de-scrambling the 16-bit data with the 8-bit precedence shift register value and the 16-bit precedence shift register value,
an input lower byte is exclusively ORed with upper 8 bits of the 8-bit precedence shift register,
an input upper byte is exclusively ORed with upper 8 bits of the 16-bit precedence shift register, and
in the exclusive OR operation, a maximal effective bit and a minimal effective bit correspond.

4. The apparatus of claim 2, wherein in a method for scrambling/de-scrambling the 16-bit data with the 8-bit precedence shift register value and the 16-bit precedence shift register value,
an input lower byte is exclusively ORed with upper 8 bits of the 8-bit precedence shift register,
an input upper byte is exclusively ORed with upper 8 bits of the 16-bit precedence shift register, and
in the exclusive OR operation, a maximal effective bit and a minimal effective bit correspond.

5. A method for scrambling/de-scrambling 16-bit data at a PCI Express protocol, the method comprising the steps of:
generating an 8-bit precedence shift register for the 16-bit data inputted;
more shifting a value of the generated 8-bit precedence shift register by 8 bits;
assigning each register value;
generating a 16-bit precedence shift register;
carrying out an XOR operation with each lower and upper bytes of the inputted data; and
outputting final 16-bit data.

6. The method of claim 5, wherein in the 16-bit shift register value generated from the 16-bit precedence shift register generator,
a ninth shift register output value is an exclusive OR (XOR) of a third shift register, a fourth shift register, a fifth shift register, an eighth shift register, and a fourteenth shift register,
a tenth shift register output value is an XOR of the fourth shift register, the fifth shift register, a sixth shift register, a ninth shift register, and a fifteenth shift register,
an eleventh shift register output value is an XOR of the fifth shift register, the sixth shift register, a seventh shift register, and a twentieth shift register,
a twelfth shift register output value is an XOR of the sixth shift register, the seventh shift register, the eighth shift register, and an eleventh shift register,
a thirteenth shift register output value is an XOR of the seventh shift register, the eighth shift register, the ninth shift register, and the twelfth shift register,
a fourteenth shift register output value is an XOR of the eighth shift register, the ninth shift register, the tenth shift register, and thirteenth shift register,
a fifteenth shift register output value is an XOR of the ninth shift register, the tenth shift register, the eleventh shift register, and a fourteenth shift register, and
a sixteenth shift register output value is an XOR of the tenth shift register, the eleventh shift register, the twelfth shift register, and the fifteenth shift register.

7. The method of claim 5, wherein in setting of an initial value of the shift register, wherein an initial value of the 8-bit precedence shift register value and an initial value of the 16-bit precedence shift register value used at a current clock are set as 16-bit precedence shift register values of an earlier clock.

8. The method of claim 6, wherein in setting of an initial value of the shift register, wherein an initial value of the 8-bit precedence shift register value and an initial value of the 16-bit precedence shift register value used at a current clock are set as 16-bit precedence shift register values of an earlier clock.

9. The method of claim 6, wherein in a method for scrambling/de-scrambling the inputted 16-bit data with the 8-bit precedence shift register value and the 16-bit precedence shift register value,
an input lower byte is exclusively ORed with upper 8 bits of the 8-bit precedence shift register,
an input upper byte is exclusively ORed with upper 8 bits of the 16-bit precedence shift register, and
in the exclusive OR operation, a maximal effective bit and a minimal effective bit correspond.

10. The method of claim 9, wherein when a signal for informing inputting of a SKP ordered-set is generated as a signal for informing inputting of a COM symbol at earlier than one clock if the COM symbol is included in data input, the 8-bit precedence shift register value is set to FFFFh and additionally, the 16-bit precedence shift register value is set to E817h and, when a signal for informing inputting of TS, FTS, Electrical Idle ordered-sets is generated, the 8-bit precedence shift register value is set to the FFFFh and additionally, the 16-bit precedence shift register value is set to the FFFFh.
